(19) United States
(12) Patent Application Publication
(10) Pub. No.: US 2022/0067425 A1
(43) Pub. Date: Mar. 3, 2022

(54) MULTI-OBJECT TRACKING ALGORITHM BASED ON OBJECT DETECTION AND FEATURE EXTRACTION COMBINATION MODEL

(71) Applicant: Tiandy Technologies CO., LTD., Tianjin (CN)

(72) Inventors: Lin DAI, Tianjin (CN); Jian WANG, Tianjin (CN); Chao XUE, Tianjin (CN); Jingbin WANG, Tianjin (CN); Ye DENG, Tianjin (CN); Longlong ZHANG, Tianjin (CN)

(73) Assignee: Tiandy Technologies CO., LTD., Tianjin (CN)

(21) Appl. No.: 17/037,687

(22) Filed: Sep. 30, 2020

(30) Foreign Application Priority Data
Aug. 25, 2020 (CN) 202010864188.X

(51) Int. Cl. G06K 9/62; G06N 3/08; G06N 3/04

(52) U.S. Cl. CPC G06K 9/629; G06K 9/6267; G06N 3/04; G06N 3/08

(57) ABSTRACT

The disclosure provides a multi-object tracking algorithm based on an object detection and feature extraction combination model, including the following steps: S1, adding an object appearance feature extraction network layer behind a prediction feature layer of an object detection tracking network having an FPN structure; S2, calculating object fused loss of the object detection tracking network having the FPN structure and added with the object appearance feature extraction network layer; S3, forming a feature comparison database utilizing a neural network during multi-frame objection detection and tracking process; and S4, comparing current image object appearance features with features in the feature comparison database, drawing an object trajectory if the objects are uniform; else adding the current image object appearance features into the feature comparison database to form a new feature comparison database, and then repeating steps S2 and S3.

### CROSS-REFERENCE TO RELATED APPLICATION

This application claims the priority benefit of China application serial no. 202010864188.X, filed on Aug. 25, 2020. The entirety of the above-mentioned patent application is hereby incorporated by reference herein and made a part of this specification.

### BACKGROUND

### Technical Field

The disclosure belongs to the field of video monitoring, and particularly relates to a multi-object tracking algorithm based on an object detection and feature extraction combination model.

### Description of Related Art

With the progress and development of society, video monitoring system is more and more widely applied and plays an increasing important role in society security. The current monitoring system cannot meet the requirements of the intelligent society because of the following main problems: object information under a large monitoring scene cannot be known, detailed information of each scenery (including pedestrian and vehicle) cannot be acquired in time, and monitored contents cannot be efficiently fed back in time.

At present, the most popular tracking algorithm based on a deep learning model can solve the above problems to a certain extent, however adaptive scenes are limiting. Currently, the main tracking algorithm is single object tracking (SOT). When the number of the objects becomes more, the time consumption brought by the algorithm is linearly increased. Although some MOT (multi-object-tracking) algorithms occur, the tracking process has many steps, usually including object detection, object feature extraction, object feature matching and other steps, and cannot realize true multi-object real-time tracking.

### SUMMARY

Aiming at the defects of the MOT in the prior art that too many steps are included, the disclosure provides a multi-object tracking algorithm based on an object detection and feature extraction combination model to reduce the algorithm steps for MOT and compress the algorithm executing time so as to improve the timeliness of tracking and to realize the real-time tracking of multiple objects.

In order to achieve the above purpose, the technical solution of the disclosure is realized as follows:

A multi-object tracking algorithm based on an object detection and feature extraction combination model, comprising the following steps:

S1, adding an object appearance feature extraction network layer behind a prediction feature layer of an object detection tracking network having an Feature Pyramid Network (FPN) structure;

wherein, the object appearance feature extraction network layer is actually formed by adding a module having feature extraction function to the FPN structure; the specific way for adding the module is disclosed in the prior art which is not repeated in detail in the disclosure;

S2, calculating object fused loss of the object detection tracking network having the FPN structure and added with the object appearance feature extraction network layer;

S3, forming a feature comparison database utilizing a neural network during multi-frame objection detection and tracking process; and

S4, comparing current image object appearance features with features in the feature comparison database, drawing an object trajectory if the objects are uniform; else adding the current image object appearance features into the feature comparison database to form a new feature comparison database, and then repeating steps S2˜S4.

Further, the object fused loss in step S2 comprises object classification loss (Loss C), frame regression loss (Loss R) and appearance feature loss (Loss F).

Further, the object fused loss in step S2 is calculated by adopting an automatic learning method for task weight, and formulas are as follows:

$$\begin{matrix}{L}_{c} = {\sum }_{i}^{N} {\sum }_{j = c} \frac{1}{2} ( \frac{1}{{e}^{{s}_{j}^{i}}} {L}_{j}^{i} + {s}_{j}^{i} ) & ( 1 ) \\ {L}_{r} = {\sum }_{i}^{N} {\sum }_{j = r} \frac{1}{2} ( \frac{1}{{e}^{{s}_{j}^{i}}} {L}_{j}^{i} + {s}_{j}^{i} ) & ( 2 ) \\ {L}_{f} = {\sum }_{i}^{N} {\sum }_{j = f} \frac{1}{2} ( \frac{1}{{e}^{{s}_{j}^{i}}} {L}_{j}^{i} + {s}_{j}^{i} ) & ( 3 ) \\ {L}_{fused} = {L}_{c} + {L}_{r} + {L}_{f} & ( 4 )\end{matrix}$$

In the formulas (1)-(4), N a number of the prediction feature layer; i=1, . . . , N; j=c, r or f, which represents the classification loss (Loss C), frame regression loss (Loss R) and appearance feature loss (Loss F) respectively; sⱼⁱ is uncertain loss of the three loss, which functions as a parameter learned in the process of model training; and

$$\frac{1}{{e}^{{s}_{j}^{i}}}$$

is used for regulating a weight of each Loss task in the final Loss Fused (L_{fused}).

Compared with the prior art, the multi-object tracking algorithm of the present disclosure has the following advantages:

When the number of tracked objects is large, the tracking algorithm has good real-time expression in the processes of box regression, box classification and feature extraction of the object. The operating time of the algorithm is relatively stable and won't be linearly increased with the increase in the number of objects.

### BRIEF DESCRIPTION OF THE DRAWINGS

The drawings constituting a part of the disclosure are used to provide a further understanding of the disclosure, and illustrative embodiments and description thereof are used to explain the disclosure and do not constitute improper limitation of the disclosure. In the drawings:

FIG. 1 is a network diagram of an FPN structure according to embodiments of the disclosure;

FIG. 2 is a diagram showing that a feature extraction layer is added behind the prediction feature diagram according to embodiments of the disclosure; and

FIG. 3 is a flowchart of a multi-object tracking algorithm according to embodiments of the disclosure.

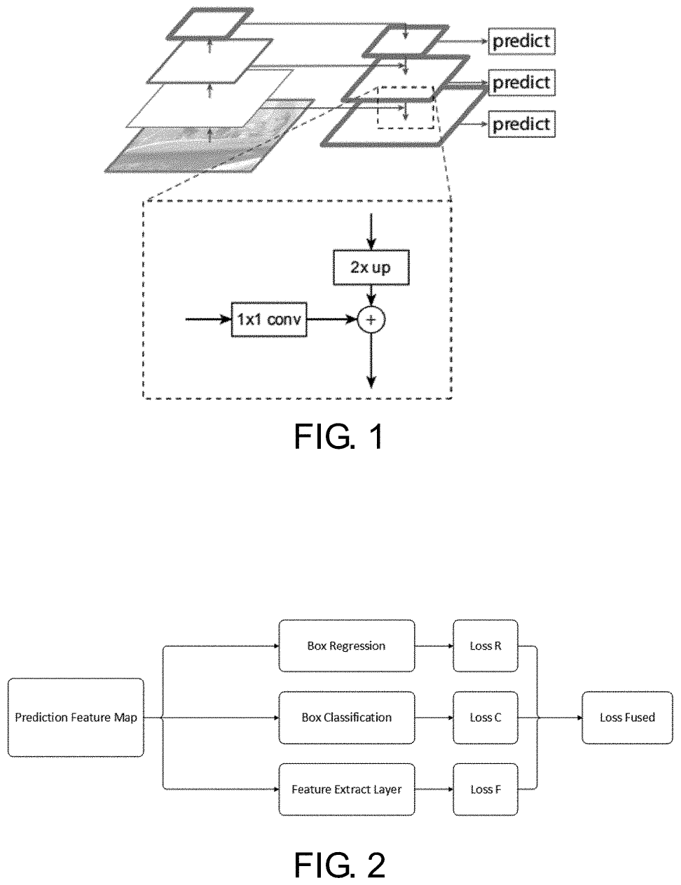

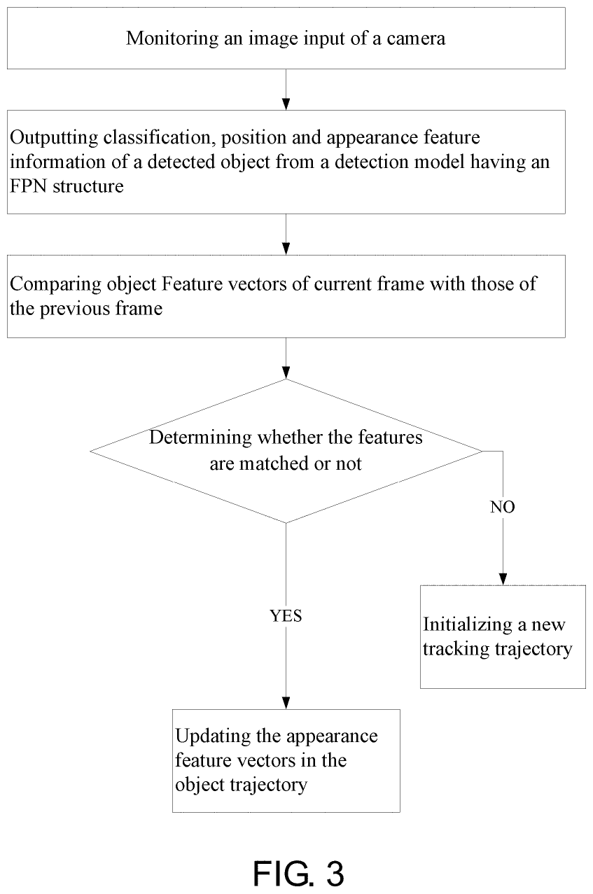

### DESCRIPTION OF THE EMBODIMENTS

It is noted that embodiments of the disclosure and features in embodiments can be mutually combined in case of no conflict.

In the description of the disclosure, it needs to be understood that the orientation or position relationships indicated by the terms “center”, “longitudinal”, “transverse”, “up”, “down”, “front”, “back”, “left”, “right”, “vertical”, “horizontal”, “top”, “bottom”, “inside” and “outside” are the orientation or position relationships shown based on accompanying drawings and are only for the convenience of describing the disclosure and simplifying the description, rather than indicating or implying that the device or element in question must have a specific orientation and must be constructed and operated in a specific orientation, and therefore cannot be understood as limiting the disclosure. In addition, the terms “first”, “second” and the like are only used to describe the purpose and cannot be understood as indicating or implying relative importance or implicitly indicating the quantity of the indicated technical features. Thus, the features defined as “first”, “second” and the like may explicitly or implicitly include one or more of the features. In the description of the disclosure, “multiple” means two or more, unless otherwise specified.

In the description of the disclosure, it should be noted that, unless otherwise specified and limited, the terms “installation”, “connection” and “linking” should be understood in a broad sense. For example, it can be a fixed connection, a detachable connection, or an integrated connection; it can be a mechanical connection or an electrical connection; it can be a direct connection or an indirect connection through an intermediate medium, and can be communication between insides of two components. For those of ordinary skill in the art, the specific meaning of the above terms in the invention can be understood through specific circumstances.

The disclosure will be described in detail in combination with drawings below.

A multi-object tracking algorithm based on an object detection and feature extraction combination model comprises the following steps:

S1, adding an object appearance feature extraction network layer behind a prediction feature layer of an object detection tracking network having an FPN structure;

wherein, the object appearance feature extraction network layer is actually formed by adding a module having feature extraction function to the FPN structure; the specific way for adding the module is disclosed in the prior art which is not repeated in detail in the disclosure;

S2, calculating object fused loss of the object detection tracking network having the FPN structure and added with the object appearance feature extraction network layer;

S3, forming a feature comparison database utilizing a neural network during multi-frame objection detection and tracking process; and

S4, comparing current image object appearance features with features in the feature comparison database, drawing an object trajectory if the objects are uniform; else adding the current image object appearance features into the feature comparison database to form a new feature comparison database, and then repeating steps S2˜S4.

Further, the object fused loss in step S2 comprises object classification loss Loss C, frame regression loss Loss R and appearance feature loss Loss F.

The object fused loss in step S2 is calculated by adopting an automatic learning method for task weight, and a formulas are as follows:

$$\begin{matrix}{L}_{c} = {\sum }_{i}^{N} {\sum }_{j = c} \frac{1}{2} ( \frac{1}{{e}^{{s}_{j}^{i}}} {L}_{j}^{i} + {s}_{j}^{i} ) & ( 1 ) \\ {L}_{r} = {\sum }_{i}^{N} {\sum }_{j = r} \frac{1}{2} ( \frac{1}{{e}^{{s}_{j}^{i}}} {L}_{j}^{i} + {s}_{j}^{i} ) & ( 2 ) \\ {L}_{f} = {\sum }_{i}^{N} {\sum }_{j = f} \frac{1}{2} ( \frac{1}{{e}^{{s}_{j}^{i}}} {L}_{j}^{i} + {s}_{j}^{i} ) & ( 3 ) \\ {L}_{fused} = {L}_{c} + {L}_{r} + {L}_{f} & ( 4 )\end{matrix}$$

In the formulas (1)-(4), N a number of the prediction feature layer; i=1, . . . , N; j=c, r or f, which represents the classification loss (Loss C), frame regression loss (Loss R) and appearance feature loss (Loss F) respectively; sⱼⁱ is uncertain loss of the three loss, which functions as a parameter learned in the process of model training; and

$$\frac{1}{{e}^{{s}_{j}^{i}}}$$

is used for regulating a weight of each Loss task in the final Loss Fused (L_{fused}). (i) The object detection tracking network having the FPN (Feature Pyramid Network) structure is selected, such as Yolo-V3 detection network.

For a convolutional neural network, different depths correspond to semantic features in different levels. The superficial network has high resolution, and more detailed features are learnt; the deep network has low resolution, and more semantic features are learnt.

Adoption of the FPN structure, on the one hand, is for better regress the position of the tracked object so as to achieve more accurate tracking. On the other hand, we need to extract the appearance information of the tracked object on the feature map having different scales. If only a deep Feature Map is selected to extract features, only features in the object semantic level may be obtained, however no superficial detailed feature will be included.

(ii) The Feature Extraction Layer, namely, feature extraction network layer, is added behind the prediction feature layer of FPN network.

In general, the detection network can perform box regression and box classification on the final prediction feature layer. In this algorithm, the Feature extraction Layer is introduced here to extract the appearance feature information of the object.

As shown in FIG. 2, the detection network outputs its feature vectors while outputting the object position and class information. The object detection and feature extraction processes which are originally performed step by step are fused together, thereby saving the implementation steps of the algorithm and saving time cost.

(iii) Loss Fused design of appearance feature loss Loss F is added:

The learning of object detection has two loss functions, namely, classification loss Loss C and frame regression loss Loss R. Cross entropy loss is adopted for Loss C and Smooth1 loss is adopted for Loss R.

For the measurement of object appearance learning, we hope that the feature vectors of the same object are close to each other, but the feature vectors of different objects are far apart. Similar to box classification, cross entropy loss is used for Loss F.

When Loss Fused is calculated, an automatic learning method for task weight is adopted and a task-independent uncertainty concept is used.

$$\begin{matrix}{L}_{c} = {\sum }_{i}^{N} {\sum }_{j = c} \frac{1}{2} ( \frac{1}{{e}^{{s}_{j}^{i}}} {L}_{j}^{i} + {s}_{j}^{i} ) & ( 1 ) \\ {L}_{r} = {\sum }_{i}^{N} {\sum }_{j = r} \frac{1}{2} ( \frac{1}{{e}^{{s}_{j}^{i}}} {L}_{j}^{i} + {s}_{j}^{i} ) & ( 2 ) \\ {L}_{f} = {\sum }_{i}^{N} {\sum }_{j = f} \frac{1}{2} ( \frac{1}{{e}^{{s}_{j}^{i}}} {L}_{j}^{i} + {s}_{j}^{i} ) & ( 3 ) \\ {L}_{fused} = {L}_{c} + {L}_{r} + {L}_{f} & ( 4 )\end{matrix}$$

In the formulas (1)-(4), N a number of the prediction feature layer; i=1, . . . , N; j=c, r or f, which represents the classification loss (Loss C), frame regression loss (Loss R) and appearance feature loss (Loss F) respectively; Sⱼⁱ is uncertain loss of the three loss, which functions as a parameter learned in the process of model training; and

$$\frac{1}{{e}^{{s}_{j}^{i}}}$$

is used for regulating a weight of each Loss task in the final Loss Fused (L_{fused}).

When the number of tracked objects is large, the tracking algorithm has good real-time expression in the processes of box regression, box classification and feature extraction of the object. The operating time of the algorithm is relatively stable and cannot be linearly increased with the increase in the number of objects.

Specific implementation method is as follows.

(i) In the object detection tracking network having the FPN structure, the Feature Extraction Layer is added behind the prediction feature layer to extraction the appearance features of the object. The extracted feature is derived from the feature maps having different scales in the FPN network. This feature combines superficial appearance information and deep semantic information, and is applied to feature extraction of the multi-object tracking algorithm.

(ii) In the MOT multi-object detection tracking network added with the Feature Extraction Layer, the Loss Fused of the object classification loss Loss C, frame regression loss Loss R and appearance feature loss Loss F is calculated by using the task weight self-learning method to dynamically regulate the Loss weight in the process of model training.

(iii) In the process of multi-frame object detection and tracking, the neural network model is used to extract the appearance feature vectors of the object in the image per frame, and these feature vectors are saved to form the feature comparison database of the multi-frame image object. At the same time, the feature vectors of the current image object are compared with those in the feature comparison database one by one so as to be used for associating the current image object with the historical image object. The associated objects in the front and back images are regarded as the same object, and the object trajectory is depicted to complete the object tracking process. The objects which are not matched and associated will be used as new trajectory objects, and their features will be added to the feature comparison database for the subsequent tracking process.

(iv) A neural network model is used to extract the appearance feature vectors of all the objects while detecting the image objects, which saves the feature extraction time of objects in sequence, and achieves the real-time tracking of objects.

The above descriptions are only preferred embodiments of the disclosure and are not intended to limit the disclosure. Any modification, equivalent replacement, improvement and the like made within the spirit and principle of the disclosure shall be included within the protection scope of the disclosure.

What is claimed is:

1. A multi-object tracking algorithm based on an object detection and feature extraction combination model, comprising the following steps:
S1, adding an object appearance feature extraction network layer behind a prediction feature layer of an object detection tracking network having an Feature Pyramid Network (FPN) structure;
S2, calculating object fused loss of the object detection tracking network having the FPN structure and added with the object appearance feature extraction network layer;
S3, forming a feature comparison database utilizing a neural network during multi-frame objection detection and tracking process; and
S4, comparing current image object appearance features with features in the feature comparison database, drawing an object trajectory if the objects are uniform; else adding the current image object appearance features into the feature comparison database to form a new feature comparison database, and then repeating steps S2˜S4.

2. The multi-object tracking algorithm according to claim 1, wherein the object fused loss in step S2 comprises object classification loss (Loss C), frame regression loss (Loss R) and appearance feature loss (Loss F).

3. The multi-object tracking algorithm according to claim 1, wherein the object fused loss in step S2 is calculated by adopting an automatic learning method for task weight, and formulas are as follows:
$$\begin{matrix}{L}_{c} = {\sum }_{i}^{N} {\sum }_{j = c} \frac{1}{2} ( \frac{1}{{e}^{{s}_{j}^{i}}} {L}_{j}^{i} + {s}_{j}^{i} ) & ( 1 ) \\ {L}_{r} = {\sum }_{i}^{N} {\sum }_{j = r} \frac{1}{2} ( \frac{1}{{e}^{{s}_{j}^{i}}} {L}_{j}^{i} + {s}_{j}^{i} ) & ( 2 ) \\ {L}_{f} = {\sum }_{i}^{N} {\sum }_{j = f} \frac{1}{2} ( \frac{1}{{e}^{{s}_{j}^{i}}} {L}_{j}^{i} + {s}_{j}^{i} ) & ( 3 ) \\ {L}_{fused} = {L}_{c} + {L}_{r} + {L}_{f} & ( 4 )\end{matrix}$$
wherein N a number of the prediction feature layer; i=1, . . . , N; j=c, r or f, which represents the classification loss (Loss C), frame regression loss (Loss R) and appearance feature loss (Loss F) respectively; sⱼⁱ is uncertain loss of the three loss, which functions as a parameter learned in the process of model training; and
$$\frac{1}{{e}^{{s}_{j}^{i}}}$$
is used for regulating a weight of each Loss task in the final Loss Fused (L_{fused}).
